(19) United States
(12) Patent Application Publication
(10) Pub. No.: US 2013/0061335 A1
(43) Pub. Date: Mar. 7, 2013

(54) Method, Apparatus, Computer Readable Media for a Storage Virtualization Middleware System

(71) Applicant: Andrew C. Schwabe, Gap, PA (US)

(72) Inventor: Andrew C. Schwabe, Gap, PA (US)

(73) Assignee: CloudPointe, LLC

(21) Appl. No.: 13/604,921

(22) Filed: Sep. 6, 2012

Related U.S. Application Data
(60) Provisional application No. 61/531,741, filed on Sep. 7, 2011.

(51) Int. Cl. G06F 21/24

(52) U.S. Cl. 726/28

(57) ABSTRACT

A method stored on a computer useable medium for sharing digital assets. The method includes a virtual workspace containing links to multiple digital assets, the digital assets being stored on one or more secondary storage mediums. The method involves displaying at least some of the links to the digital assets in the workspace for an individual to access; receiving a request from the individual to access one of the digital assets in the workspace; retrieving a storage connector stored on the first storage medium, the storage connector being specifically associated with the digital asset; using the storage connector to translate the request to access from the individual to a request to access associated with the digital asset; and accessing the actual digital asset in response to the individual's request. A system and product are also disclosed for use with the method.

### RELATED APPLICATION

This application is related to and claims priority from U.S. Provisional Patent Application Ser. No. 61/531,741, filed on Sep. 7, 2011, the disclosure of which is incorporated herein by reference in its entirety.

### BACKGROUND

Many applications on the market permit a third party, with pre-established credentials (e.g, a login and password) to access an owner's computer system or storage system to view, print, and/or edit a digital asset, such as a document, data file, spread sheet, PDF, etc., of the owner. In those circumstances, the third party's access is limited to only the particular application that they had credentials for. If the owner wants the third party to access two or more different file types, such as a text file and a database file, the user must provide the third party with credentials to enter each application.

In order to simplify the third party's access to the files, the owner of a digital asset typically e-mails the files to the third party. The problem with such a solution is the loss of control over the digital asset. The third party could forward the asset to other individuals.

Also, depending on the configuration of the software, the digital asset may only be accessible if the third party's computer has the correct software application.

Thus, a need exists for a system for controlling access to and control over digital assets.

### SUMMARY OF THE INVENTION

The present invention relates to a method stored on a computer useable medium for sharing digital assets. The method includes the steps of: providing a first storage medium containing a virtual workspace containing links to multiple digital assets, at least a plurality of the digital assets being stored on one or more secondary storage mediums; displaying at least some of the links to the digital assets in the workspace for an individual to access, the digital assets and the virtual workspace being stored in locations remote from the individual; receiving a request from the individual to access one of the digital assets in the workspace; confirming whether the individual has rights to access the digital asset; retrieving a storage connector stored on the first storage medium, the storage connector being specifically associated with the digital asset; using the storage connector to translate the request to access from the individual to a request to access associated with the digital asset; and accessing the actual digital asset in response to the individual's request.

The storage connector may include restrictions on actions that can be performed using the digital asset. The step of using the storage connector may include limiting the individual's use of the digital asset in accordance with the restrictions.

There preferably are multiple digital assets stored on multiple secondary storage mediums. The method preferably includes creating a storage connector to each digital asset on its storage medium, and storing the storage connector on the first computer useable medium.

The method may encrypt functionality and security credentials for accessing the digital assets on the storage connector. The security credentials may include login credentials for accessing the digital asset using a computer program stored on one of the secondary storage mediums. The accessing of the actual digital asset preferably involves providing the login credentials to the computer program for accessing the digital asset.

Preferably an electronic invitation is sent to an individual to access the workspace, the electronic invitation including an internet link to a system controlling access to the workspace.

The method preferably prompts an individual to enter credentials for accessing the workspace.

At least one of the digital assets is accessible by a first computer program stored on one of the secondary storage medium, and at least another of the digital assets is accessible by a second computer program stored on one of the secondary storage mediums, the second computer program being different from the first computer program. Preferably the individuals access to the digital assets involves using the first and/or second computer program, and wherein the storage connector includes credentials useable by the first or second computer program for accessing the digital asset.

The first storage medium includes a bus for routing a request from one or more individuals for accessing a digital asset, the bus having storage connectors associated with it. The method preferably uses the bus to determine which storage connector to use in response to receipt of a request from the individual.

The method may include a document masking feature for use as a deterrent against unauthorized viewing by a third party and screen capture/scraping by unauthorized individuals. The method involves obscuring a portion of the digital file by applying a layer on top of a portion of the view of the digital asset, the layer not obscuring the entire view of the digital asset, instead leaving a portion of the view unobscured. The layer or viewport can be moved relative to the view of the digital asset so that that different portions of the view of the digital asset can be seen.

The method may also track access by the individual and log the individual's activities in a log file.

The present invention also includes a non-transitory computer program product and a system.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawings and the description are to be regarded as illustrative in nature, and not as restrictive.

### BRIEF DESCRIPTION OF THE DRAWINGS

For the purpose of illustrating the invention, the drawings show forms of the invention which are presently preferred; it being understood, however, that the invention is not limited to the precise arrangement and instrumentality shown.

FIG. 1 is an illustration of one electronic entry form for use in creating a storage connector for a digital asset according to an embodiment of the present invention.

FIG. 2 is an illustration of one electronic entry form for creating a workspace according to an embodiment of the present invention.

FIG. 3 is an illustration of one electronic entry form for associating electronic addresses for individuals permitted to access a workspace according to an embodiment of the present invention.

FIG. 4 is an illustration of an example of a display of virtual digital assets in a workspace according to an embodiment of the present invention.

FIG. 5 is an illustration of an embodiment of use of the present invention.

FIG. 6 is an illustration of an embodiment of establishing a workspace according to the present invention.

FIG. 7 is an illustration of one embodiment of a virtualization bus according to an embodiment of the present invention.

FIG. 8 is an illustration of one embodiment of a system according to an embodiment of the present invention.

FIG. 9 is an illustration of the masking feature in an embodiment of the present invention.

FIG. 10 is another illustration of the masking feature in an embodiment of the present invention.

FIG. 11 depicts one embodiment of the implementation of the masking feature according to the present invention.

FIG. 12 depicts another embodiment of the implementation of the masking feature according to the present invention.

FIG. 13 depicts other aspects of the masking feature according to the present invention.

FIG. 14 illustrates an embodiment of the use of a positive recipient identification (PRI) system for authenticating a third party attempting to access a workspace according to an embodiment of the present invention.

FIG. 15 is an illustration of one electronic entry form for use in configuring the PRI functionality.

### DESCRIPTION OF THE PREFERRED EMBODIMENTS

It is to be understood that the following description is exemplary and is intended to provide further explanation of the invention as claimed.

The following provides a functional description of a storage virtualization system according to the present invention. The storage virtualization system may be referred to as the system in the description below.

The system provides an extensible platform that extends core storage functions (read, write, modify, list, delete, etc.), but allows the actual underlying storage to be user replaceable. This becomes highly relevant when an enterprise builds their systems on one platform, for example. Microsoft SharePoint, and then wishes to switch to low cost cloud storage later.

The advantages of the disclosed system include offering a way for enterprises to: a) Securely connect to on and off-premise storage from any location; b) Exchange data between different storage platforms; c) Ability to consume digital assets from multiple user endpoints without the need to duplicate or store snapshots, thus reducing risk; d) Extend client access licenses for licensed storage to external (unlicensed) users using credential brokering; and e) Reduce or eliminate data duplication, and centralize content distribution around a single source of the originating content.

The roles of the types of users of the systems are: Digital Asset Owner (a user who owns or controls content to be shared with others, and who has credentials to access their content in the proprietary storage system); and, Digital Asset Consumer (user who is granted access to digital assets via workspaces).

The following are components of the system which will be explained in further detail below: Storage connectors, Storage-mapped Collaborative Content Workspace, and Storage Virtualization Bus.

In an embodiment, the system was implemented using Java™ programming language, but the system may be implemented in other programming languages. Considerations for selecting a development platform should include reviewing what tools are available to build the storage connectors, whether support is available as open source or whether 3rd party tools must be licensed.

The following includes walkthroughs of an embodiment of the system to explain the operation of the system.

This section will go through a high level overview of the two roles of users using the CloudPointe™ system which implements this technology.

First a walk through of the system for a Digital Asset Owner. The Digital Asset Owner may use the system for the following: connect the CloudPointe™ system to an in-house enterprise storage; and, invite Digital Asset Consumers to securely access digital assets, which reside on an in-house enterprise storage.

The first step is for the Digital Asset Owner to log into the system using credentials previously provided by the system.

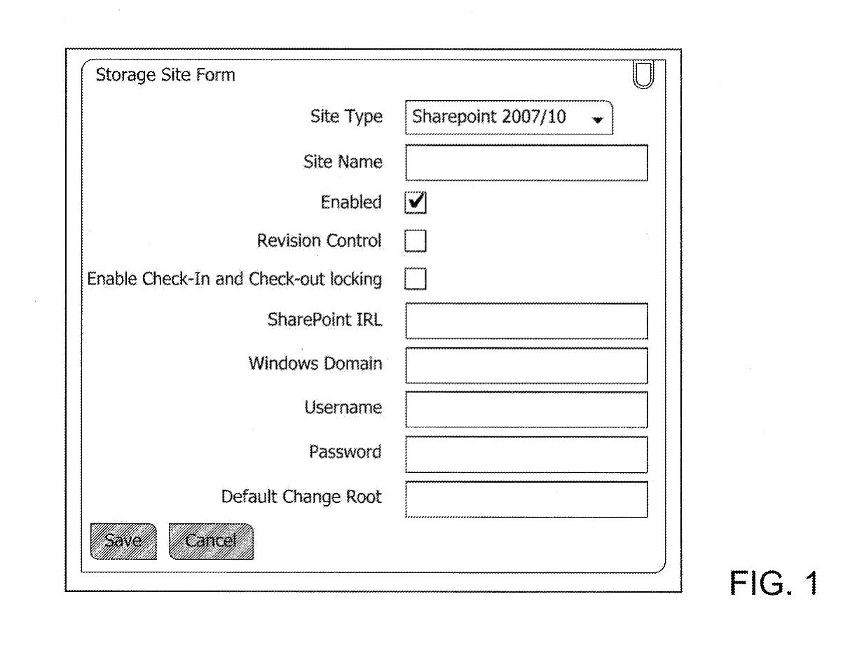

The second step is to create a storage connection. Once logged in, the system permits the user to create a link between the system and the storage location of the Digital Asset Owner's data. The system provides a “Storage Sites” tab or link, which provides choices related to the storage location including the option of selecting a button for a “New Storage Site”. This brings up a “Storage Site Form” screen which requires information needed to connect to the Digital Asset Owner's storage. FIG. 1 illustrates one embodiment of a dialogue box for entering a new storage form. The first option is to select what kind of storage you want to connect to (which the system uses to determine which connector to use), followed by the security credentials needed to access this storage.

The credentials provided here are the ones needed to access the remote storage, and may be provided by the service provider or, if the storage is on the Digital Asset Owner's or a third party's secure server or other storage medium, would be the login credentials, which may, for example, be provided by an information technology administrator at the company. Once provided, this information is encrypted and stored by the system. Preferably the Digital Asset Consumers cannot see this information. When this form is completed and submitted, the storage connection is saved by the system.

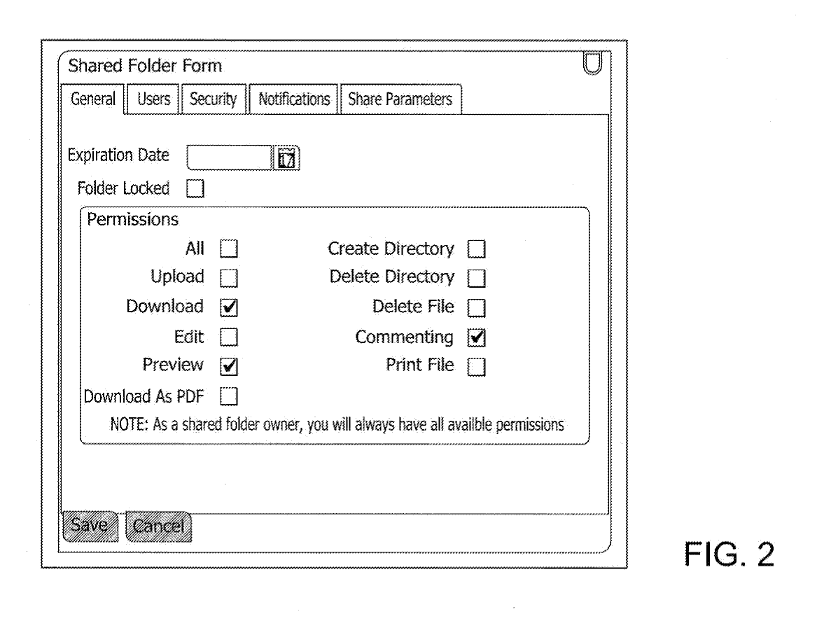

The third step is to create a workspace or “Shared Folder”. Now that the storage connection is established, the Digital Asset Owner clicks on the “Shared Folder” tab, and clicks on the “New Shared Folder” button. This brings up the properties form for a new workspace. The Digital Asset Owner selects the storage connection that was setup in the previous step, and then assigns preferences for the workspace such as: Default security privileges for others (Digital Asset Consumers). FIG. 2 illustrates some preferred options for assigning to the shared folder. This is where the Digital Asset Owner can specify restrictions as to what others may do with the shared digital assets, such as upload, download, edit, preview, download as PDF, create and/or delete directories, delete files, provide comments, print file. The Digital Asset Owner can select which options are available for users of the folder. The system may also allow the Digital Asset Owner to also set preferences for the root directory (the directory on the storage connection where digital assets should be served, similar to the ‘document root’ of an http server), such as allowing or blocking certain filters.

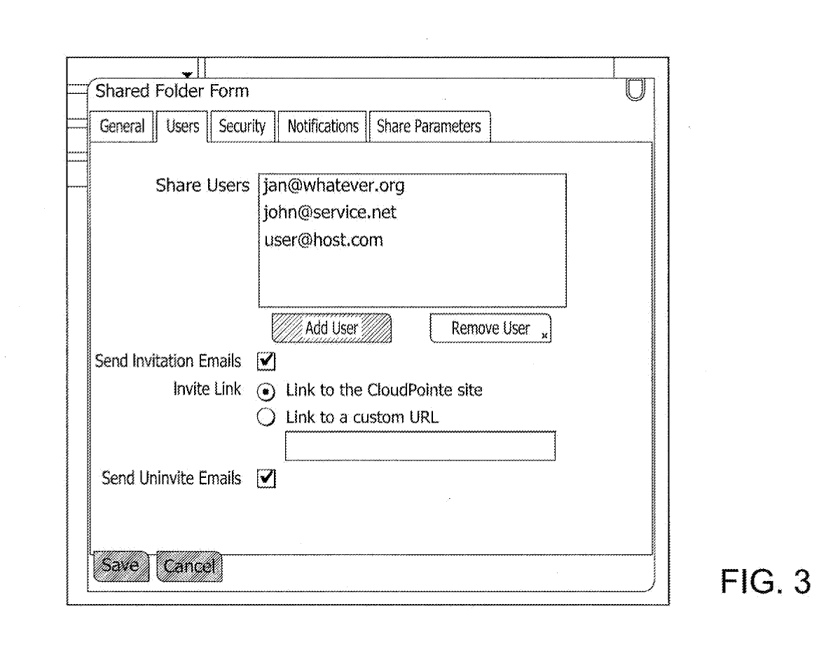

Next the system includes an option for the Digital Asset Owner to select who may access the folder. FIG. 3 illustrates a dialogue box where individual email addresses for permitted users (Digital Asset Consumers) are entered so as to permit access to the workspace. Once the options are selected and/or entered, the Digital Asset Owner clicks the “save” button and the workspace is configured, and invitation email messages are sent to each of the invited people (Digital Asset Consumers).

A walkthrough of the operation of an embodiment of the system from the Digital Asset Consumer perspective will now be explained. The e-mail invitation to the Digital Asset Consumer from a Digital Asset Owner includes a link to the shared folder/Workspace which contains the digital assets that are being shared. This may be one document or multiple documents or files, in one or more directories. The email contains a URL used to access the shared folder. If this is the first time that the Digital Asset Consumer has accessed the system, additional information will be sent via email instructing them on how to configure a password for the system.

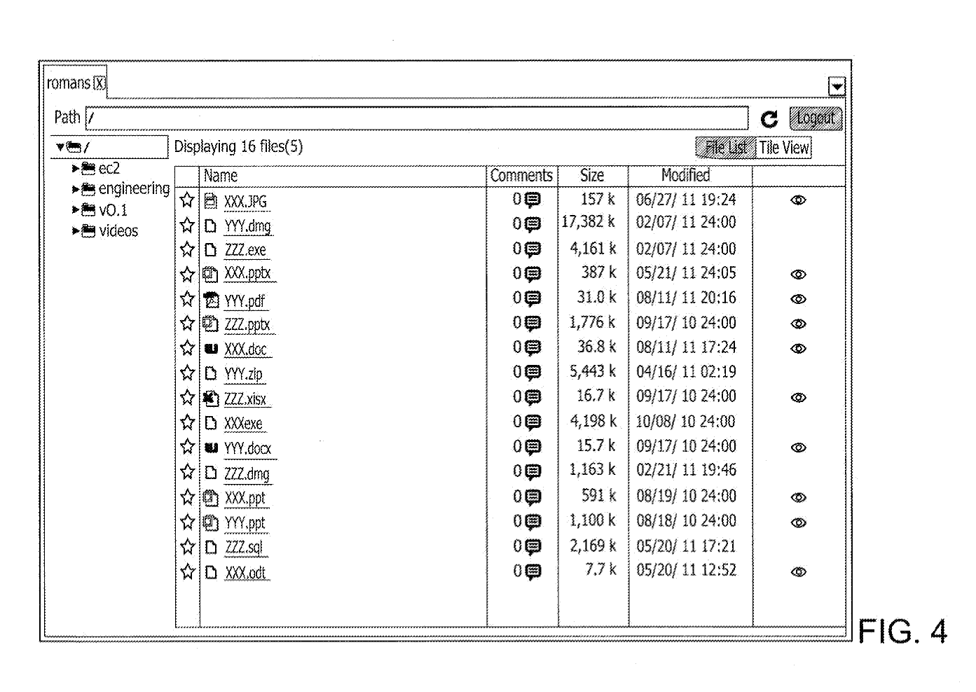

Upon selecting the URL, a prompt for credentials is provided to the Digital Asset Consumer. The Digital Asset Consumer enters their email address as the username and their password (which they get to choose the first time they are accessing the system). Upon successful login, the Digital Asset Consumer is provided with a list of shared digital assets that they have access to. FIG. 4 illustrates an exemplary list of shared digital assets as viewed by the Digital Asset Consumer. Depending on the security privileges that the Digital Asset Owner has set, the Digital Asset Consumer will have options to perform certain actions on each digital asset. The specific list of digital assets displayed comes from the Digital Asset Owner's storage connection, from inside the specified “root directory.” In certain embodiments, the system connects to the remote storage and calls the “list” method via the appropriate storage connectors. This returns a list of the digital assets from the remote storage for display to the Digital Asset Consumer.

After the list of assets is displayed to the Digital Asset Consumer, they may select and perform certain actions on the digital assets (e.g., documents), such as only preview, or provide comments on a selected digital asset. For example, if a Digital Asset Owner has indicated that a particular Digital Asset Consumer can only preview and comment on certain digital assets, this means that the Digital Asset Owner has chosen to not allow the Digital Asset Consumer to have the ability to download, edit or delete assets. In the illustrated embodiment, when the Digital Asset Consumer clicks on the “preview” icon (which is depicted as an eye), the document is opened in the system document viewer. In certain embodiments, when the user clicks the preview icon, the system connects to the remote storage to access the selected digital asset. This viewer opens a view-only version of the document. As such, the system does not require the Digital Asset Consumer to have the application associated with the document (for example, Microsoft Word). The viewer permits the Digital Asset Consumer to browse, page through and comment on the document, but does not permit them to save or share it with anybody else. In addition, the document is preferably not downloaded to the Digital Asset Consumer's computer, so there is no residual data left on the Digital Asset Consumer's system after a permitted view. In certain embodiments of the invention, the Digital Asset Consumer may download, edit, delete, and perform other operations on the shared digital assets according to the security settings of the shared digital assets set by the Digital Asset Owner.

It is envisioned that the system may include a brokered security model. That is, the system uses a security model where the security credentials of Digital Asset Owners are brokered for Digital Asset Consumers. The following is an explanation of a brokered security model according to the present invention. Examples will be provided referencing a particular embodiment of the system that has been implemented and is a working example of this technology platform.

Digital Asset Owners may have access to multiple sources of digital assets, such as their company's Microsoft SharePoint™ server, videos and photos on an FTP site, proposals in Salesforce.com™, and other files on Amazon S3™.

In order to allow others to access to these organization-specific digital assets, it requires that those users have the credentials to do so. For SharePoint™, it means asking an information technology administrator for a new login and making sure the security is locked down so they can only see certain digital assets. For other technologies, it requires equally complex and involved processes to provide access. As a result, most organizations have simply decided to duplicate those resources and email them or push them to a more publicly accessible storage location. This causes many issues, specifically risk related issues, with data duplication, broken workflow, and a loss of control since it is no longer easy to know where a file may end up (for example, the people who are initially sent the file may resend it to other people).

The advantage of the present invention is that it provides a way to allow Digital Asset Consumers to access Digital Asset Owner's content, but without knowing Digital Asset Owner's credentials, and without needing their own credentials to access the storage directly.

For example, a Digital Asset Owner establishes a connection to his SharePoint server, creates a workspace on the system, and invites a Digital Asset Consumer to view the Digital Asset Owner's Microsoft Word document.

The Digital Asset Consumer accesses the workspace, and logs in using his/her system username and password (which is unique for each user, preferably based on their email address). When they request to access to the shared Microsoft Word document, the system uses an appropriate storage connector to communicate with SharePoint. The SharePoint connector (operating behind the scenes, and unbeknownst to the Digital Asset Consumer) uses the Digital Asset Owner's credentials to connect and retrieve the shared file.

The Digital Asset Consumer does not know where the document originated from, and doesn't need to. In this scenario, a review of the SharePoint access logs would show that the Digital Asset Owner connected and retrieved the document. Reviewing the access logs of the current system will show that the Digital Asset Consumer requested the document. The system may be configured to log all activity related to accessing a digital asset, including date/time, which asset was accessed, which Digital Access Customer accessed the file, and what type of access (view only, print, etc.). Thus, the Digital Access Owner has the ability, through the activity log, to monitor access to each digital asset.

The benefits of this brokered security model are multiple. Information technology groups at a company no longer need to provide accounts for every Digital Asset Consumer. Training and help desk support no longer is needed to help Digital Asset Consumers access resources on less common storage systems, such as FTP, SFTP, Amazon S3, etc. Digital Asset Consumers do not need to have proprietary software on their computers to review documents (Office files, engineering documents, Photoshop files, videos, etc.).

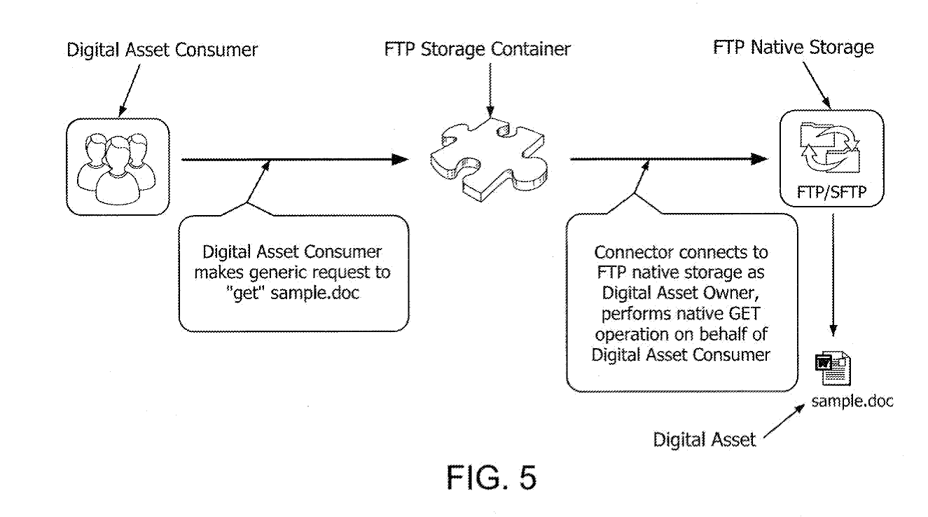

FIG. 5 illustrates an example of the operation of storage connectors. In order to be able to connect to multiple storage platforms, a specifically built connector may be implemented for each distinct system that is needed to access the shared digital assets. For example, supporting FTP requires an FTP-specific connector, while supporting Microsoft SharePoint™, Documentum™, Alfresco™ and other enterprise systems all use a common WebDAV™ connector.

Each storage connector may be configured to translate generic storage requests into platform-specific storage requests. The system is configured to provide authentication credentials to the init( ) method by the Digital Asset Owner, where they are securely maintained in persistent memory while the session is active. This has the advantage of providing a secured system.

In certain configurations of the system, each connector may include the following components. The components may be functions or methods that are exposed in an object oriented language such as Java™.
a. An init method may be included with each connector. The init method may initialize a connection to the storage passing in all required credentials.
b. A clientFileExists method may be included with each connector. The clientFileExists method may confirm the existence of a file object.
c. A clientFolderExists method may be included with each connector. The clientFolderExists method may confirm the existence of a folder object.
d. A download method may be included with each connector. The download method may request a copy of a specified file object.
e. A list method may be included with each connector. The list method may retrieve a listing of file and folder objects within the specified container or folder. In some embodiments, the list method takes as arguments a workspace id and a path. When the system receives the list request, it looks up the workspace owner, retrieves their credentials for the remote storage, initializes the connection, then proceeds to use the methods associated with the remote storage to retrieve the list of remote files. Once retrieved, the list is reformatted into a format associated with the present invention that is common to all the other storage connectors, and the results are returned for the user to view.
f. A backupFile method may be included with each connector. The backupFile method may store a copy of the current version of a file as a revision level.
g. A checkinFile method may be included with each connector. The checkinFile method may remove an exclusive lock.
h. A checkoutFile method may be included with each connector. The checkoutFile method may lock a file for exclusive use.
i. A mkdir method may be included with each connector. The mkdir method may create a new folder object.
j. A moveFile method may be included with each connector. The moveFile method may rename or relocate a file object.
k. A removeFile method may be included with each connector. The removeFile method may remove or delete a file object.
l. A renameFolder method may be included with each connector. The renameFolder method may rename or relocate a folder object.
m. A rmdir method may be included with each connector. The rmdir method may remove a folder object.
n. A testConnection method may be included with each connector. The testConnection method may test connection to the storage.
o. An upload method may be included with each connector. The upload method may store a new file object.

Depending on the type of storage connector, the actual methods used to perform the action may be different. The number of methods may be different. The functionality may be differently arranged than presented above. For example, if the list method was called for an FTP site, the connector actually invokes the “Is” command to retrieve the list of files. For the SharePoint connector, which utilizes WebDAV protocol over NTLMv2, the connector issues a “PROPFIND” command, which retrieves the list of files and their properties, which are formatted as described above.

Each of the other methods may be handled in the same way, where a “logical” request is converted into a platform specific request by the connector.

The system may perform at least some of the actions disclosed herein using the methods described above. This includes methods like copying file objects, generating thumbnail previews of content, storing revisions of documents, etc. A number of the methods are intended to only be utilized by the Digital Asset Owner. Other methods can be used by Digital Access Consumers depending on the permissions granted by the Digital Asset Owner.

Using the connector, when a Digital Asset Consumer or Owner requests an action, such as uploading a new file object to storage, the connector's functions to accept and validate the request, and then perform the transaction of uploading the file object to the native storage. Since the connector is specifically designed to “talk” to the native storage, it will often utilize 3rd party or proprietary tools to complete the transaction.

The storage connector may be a translation utility and may work with the storage virtualization bus.

A storage-mapped collaborative content workspace will now be disclosed. In the context of this technology platform, the system creates logical workspaces that map directly to an existing folder or container of file and/or folder objects. This logical workspace exposes services for collaborative access to the underlying content, but is physically removed from the storage.

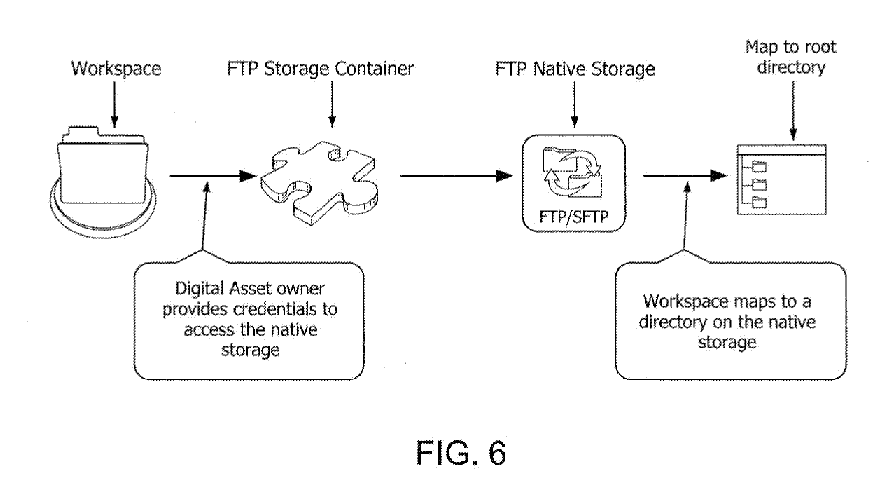

FIG. 6 illustrates an example of an embodiment or module of the system where a workspace may map to a single storage source, which is mapped to its associated storage connector as discussed above. The workspace definition stores any workspace-specific settings, such as the root directory of the container where the digital assets that are being shared are located.

Once defined, the workspace object can be used and exposed for sharing to Digital Asset Consumers, while using the underlying application programming interface (API) methods provided by the storage connector.

When a workspace is defined, the Digital Asset Owner is required to provide security credentials necessary to access the mapped storage location. The exact list of information required is dependent on the type of storage. For example, FTP connections require a hostname, username, password, passive or active setting, and a root directory, while SharePoint connections require a SharePoint URL, username, password, NT Domain, and an initial root directory. When a workspace is instantiated, the Digital Asset Owner's credentials are used to initiate a session to the native storage.

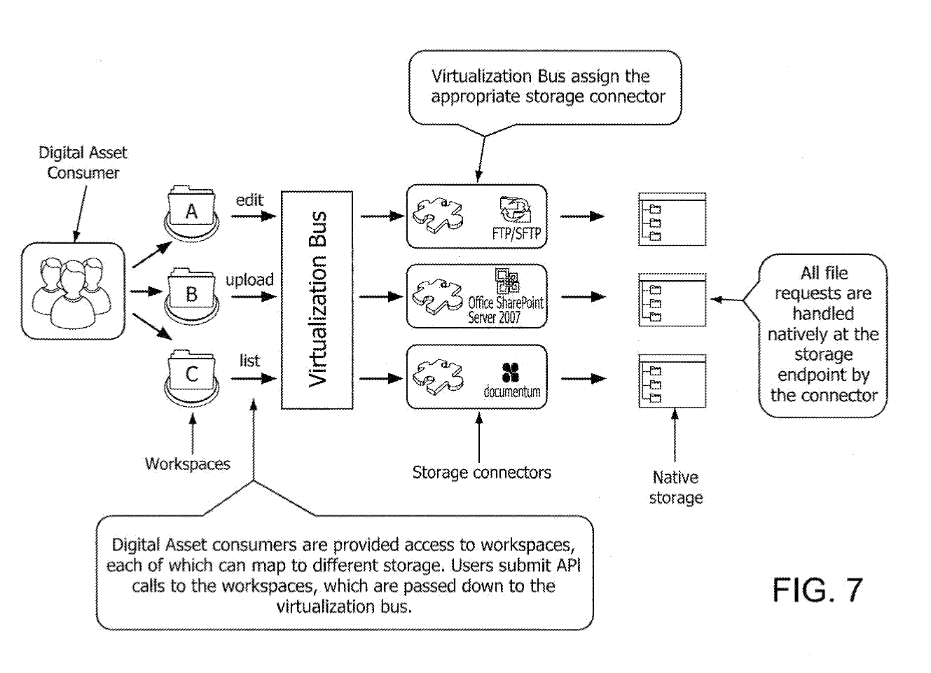

FIG. 7 illustrates an example of one configuration of a storage virtualization bus for use in the system. The storage virtualization bus is designed to function as the request routing point that interprets generic storage requests from one or more Digital Asset Consumers into platform-specific storage requests. It operates by exposing an application programming interface (API) that takes generic storage requests and uses storage connectors along with brokered credential tunneling to access digital assets on the storage endpoint.

An example of the storage virtualization bus requires the following logical objects to be available: 1) One or more storage connectors. 2) A collaborative content workspace, mapped to one or more storage sources. 3) An authenticated Digital Asset Consumer with access to the workspace.

A Digital Asset Consumer receives an invitation email with a link to a specific workspace and instructions for accessing the workspace and preferably the files. After the Digital Asset Consumer is authenticated, they are presented with a listing of digital assets available to them. When actions are requested by the Digital Asset Consumer for the workspace, the storage virtualization bus routes the request (such as a file download), by determining which storage connector it uses, and using the workspace's definition to determine credentials. The workspace validates the request, and passes along the storage request to its underlying storage connector.

The storage connector is already connected using the Digital Asset Owner's credentials, so when the request reaches the storage connector, it accesses the storage location through a session “initiated” by the Digital Asset Owner.

The system provides the advantage that the brokered credential tunneling effectively allows the Digital Asset Consumer to access a Digital Asset Owner's data in a secure controlled way, without the Digital Asset Consumer knowing what the underlying storage is, or with which credentials the connection was made.

In certain embodiments, the system implements check-in and check-out services as well as revision control for all supported storage types. In the scenarios where the storage platform has built-in support for check-in/check-out and revision control (SharePoint, for example), the system's connector handles the proprietary method to lock the file within SharePoint.

In one embodiment, for a document being shared from a SharePoint server, if two users request the same document exclusively for writing, and the first user requests the document through the system remotely, that user will receive an exclusive lock on the file. The file is locked by the system, and also at the SharePoint server. The second user, whether accessing the file through SharePoint directly or through the system remotely, will be denied exclusive access until the first user stores or cancels their changes and checks the document back in.

When a remote user accesses digital assets remotely, they either view the document through the system viewing tools, or if they have write control, they have access to the source document. In this case, the entire source document is copied from the source location and sent via SSL encrypted HTTP session to the Digital Asset Consumer's computer.

An advantage the present system provides is platform independence. In some embodiments, the system is designed to provide a standards-compliant interface to proprietary storage systems. As a result, all tools are web based and available to end users working on conventional operating systems.

Digital Asset Consumers may use a web browser on a Mac, PC or Linux computer running any conventional web browser to access the system. In addition, users may have access to a mobile web application that provides a subset of the whole application functionality, enabling true secure mobile access to proprietary storage.

Some storage systems are heavily biased to certain client software. For example, Microsoft SharePoint is heavily biased toward Microsoft Windows and the Internet Explorer browser. FTP and Secure FTP storage require special software or knowledge of complex command sets. Cloud based storage is often even more complex. For example, Amazon S3 is widely considered a developer-only tool since consumer oriented tools do not readily exist for using cloud storage.

Since the system uses connectors to convert logical storage requests to proprietary requests, the actual storage platform used to store the underlying digital assets may be transparent to the user. For example, users on a PC may access digital assets on a Linux server. Mac users may access digital assets on a Microsoft SharePoint server. Storage endpoints offer cross platform independence with the current system. The system may enable multiple users to access a single workspace, and may be a combination of any number of mobile, desktop and different OS clients. i.e. Mac, PC, Linux and mobile users may all access any workspace at the same time, with different types of actual storage used.

The following are some advantages of embodiments of the system. The system provides a storage virtualization middleware platform that offers the following advantages:
a. Provides a simplified interface which can connect to multiple storage platforms. Connectors allow for expansion and adaptation to new storage platforms.
b. Provides services to exchange, migrate and access data across multiple storage platforms. The common API allows the workspaces to be scripted such that managed file transfer can be done between native storage platforms.
c. Provides a secure consistent way for consumption of content from any storage platform. Third party applications, developers and other user endpoints (such as mobile, embedded applications, etc.) can build once and adapt to use any other kind of storage. Allows multiple consumers to access storage mapped workspaces around a single source of content reduces data duplication and facilitates centralized content distribution.
d. Effectively reduce the volume of client access licenses needed for enterprise storage. Connections from the platform to native storage always use the Digital Asset Owner's credentials while any volume of Digital Asset Consumers can still have access. Digital Asset Consumers never need to see or know credentials for the native storage.

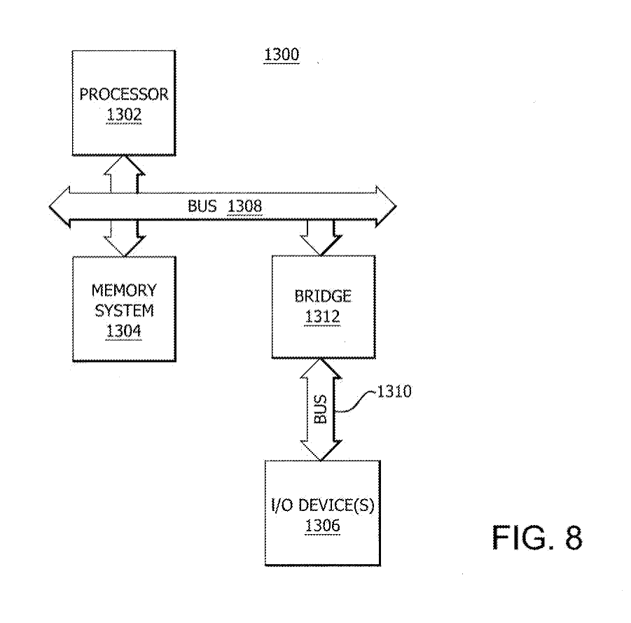

FIG. 8 is a simplified functional block diagram of a computer system 1300. The system can be implemented in hardware, software or some combination thereof.

As shown in FIG. 8, the computer system 1300 includes a processor 1302, a memory system 1304, including a storage medium, and one or more input/output (I/O) devices 1306 in communication by a communication ‘fabric’. The communication fabric can be implemented in a variety of ways and may include one or more computer buses 1308, 1310 and/or bridge devices 1312 as shown in FIG. 8. The I/O devices 1306 can include network adapters and/or mass secondary storage devices or mediums. Referring to FIGS. 5 and 8, the Digital Asset Consumer may access the computer system 1300 via one of the I/O devices 1306. The storage virtualization system may reside on the computer system 1300, in the memory system. The computer system 1300 may present to the Digital Asset Consumer digital assets and/or the computer system 1300 may transmit to another computer instructions for presenting digital assets to the Digital Asset Consumer. For example, in a web based example of the system, the computer system 1300 may send to a computer of the Digital Asset Consumer Java™ instructions for a web browser running on the computer of the Digital Asset Consumer to execute. The Java instructions could be executed on another computer, which may access the memory system 1304 via the I/O devices 1308. A representation (links) of the digital assets and/or the connectors may be stored in memory system 1304 (first storage medium).

The system 1300 may respond to a request from a Digital Asset Consumer such as “get sample.doc” by determining an appropriate connector to access the actual “sample.doc” and then executing the connector. The connector may then access a system such as an FTP Native Storage to access the actual “sample.doc” digital asset on a secondary storage medium. The connector would may then send the actual document to the computer system 1300 via the I/O devices or the connector may send the actual document directly to the computer of the Digital Asset Consumer. Preferably the digital asset remains stored on the secondary storage medium.

The computer instructions/program code for the storage virtualization system may reside on the computer system 1300, but may be executed on or through different computer systems. For example, on a computer system of the Digital Asset Consumer, a computer system associated with the FTP native storage system, and/or different computer systems associated with the Digital Asset Consumer, the storage virtualization system, and/or computer systems associated with the actual storage of the digital assets.

Components of the storage virtualization system may be stored on different computers and/or storage devices (e.g., mediums). Components of the storage virtualization system may be executed on different computers. The method may be implemented through program code or program modules stored on a storage medium.

The communication fabric may be in communication with many networks including the Internet and local area networks. The storage virtualization system may store a representation of the digital assets, executable instructions, and/or connectors across the communication fabric.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium, which may be in a physical form.

Disclosed is a method of sharing virtual digital assets. The method including displaying one or more virtual digital assets for one or more individuals to access, and in response to a request to access a virtual digital asset of the one or more virtual digital assets from a first individual of the one or more individuals, retrieving a storage connector for the virtual digital asset; using the storage connector to translate the request to access the virtual digital asset to a request to access an actual digital asset; and accessing the actual file. The digital assets may be files. The first individual may be different than a second individual that owns the actual file. The request may be from a first computer system and the actual file resides on a second computer system.

The method may include using stored credentials associated with the actual file to access the actual file. The credentials associated with the actual file may be stored on a third computer system. The first individual may be a Digital Asset Consumer and the second individual is a Digital Asset Owner. Displaying may include displaying the one or more virtual files from a third computer system.

A non-transitory computer program product is also disclosed. The non-transitory computer program product may include a computer usable medium having a computer readable program code embodied therein, said computer readable program code adapted to be executed to implement a method for sharing virtual files, said method comprising: displaying one or more virtual files for one or more individuals to access, and in response to a request to access a virtual file of the one or more virtual files from a first individual of the one or more individuals, retrieving a storage connector for the virtual file; using the storage connector to translate the request to access the virtual file to a request to access an actual file; and accessing the actual file.

The present invention also encompasses an apparatus including a processor configured to perform the following method displaying one or more virtual files for one or more individuals to access, and in response to a request to access a virtual file of the one or more virtual files from a first individual of the one or more individuals, retrieving a storage connector for the virtual file; using the storage connector to translate the request to access the virtual file to a request to access an actual file; and accessing the actual file.

The present invention also includes a virtualization bus. The virtualization bus includes workspaces, and storage connectors configured to translate requests from the workspaces to native storage, wherein the virtualization bus is configured to take requests from users for access to digital assets and select storage connector to satisfy the request from the user.

The system also includes a document masking feature for use as a deterrent against unauthorized “over-the-shoulder” viewing and screen capture/scraping by unauthorized individuals. This feature of the system helps to protect ownership control of digital assets that are shared with untrusted 3rd parties or in open environments.

One of the biggest threats to sharing any intellectual property displayed on a computer screen is the threat of screen capture, by computer software that captures the visible area to the clipboard or image file, or by a mobile or portal electronic device such as a camera or a mobile phone with a built in digital camera. The present system optionally includes a document masking technology as a deterrent to screen capture.

There is, of course, no way to completely eliminate the use of image capture software or devices. Thus, the masking feature only acts as a deterrent by increasing the difficulty associated with unauthorized screen captures. The masking system operates by permitting only portions of a document to be displayed on screen at any given time, making screen capture much more complex and time consuming.

As described above, the present system includes a viewing module that creates dynamic previews of documents for users. The document masking system is an add-on feature that incorporates an interactive visual layer on top of the preview.

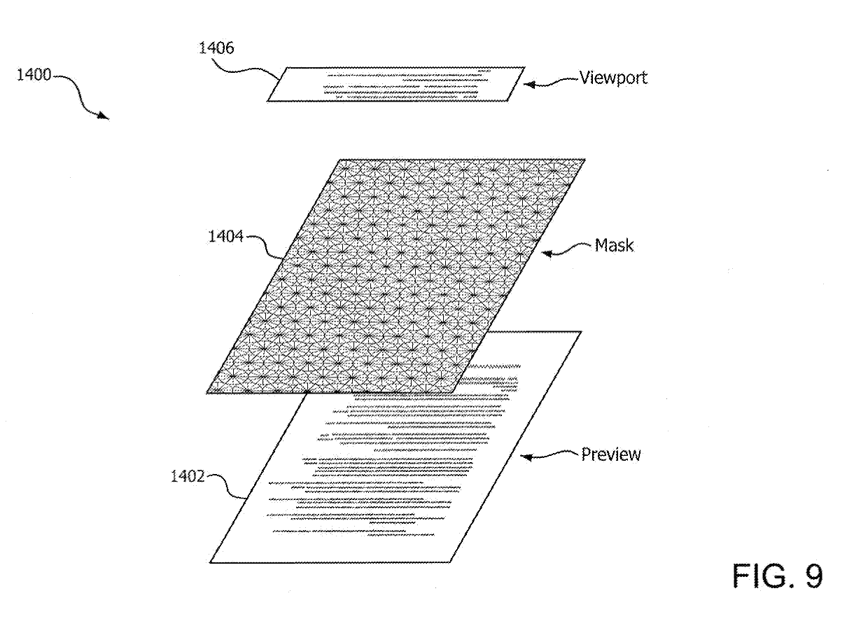

Referring to FIG. 9, the masking feature 1400 is generally shown, and includes a bottom layer 1402 which is preferably the preview layer already generated by the system. A middle layer 1404 is provided which is a mask that sits on top of the preview and covers it so that it is no longer visible. The mask can be completely opaque, or can be partially transparent, for example 20% transparent through the use of a texture in order to function as a distortion mask. The amount of transparency that is desired may vary depending on the color of the mask, color of the typeset, size of typeset, type of texture, etc. The amount of transparency can be selected so as to still permit the user to see enough of the underlying preview to assist them in navigation of the viewport and paging through large documents.

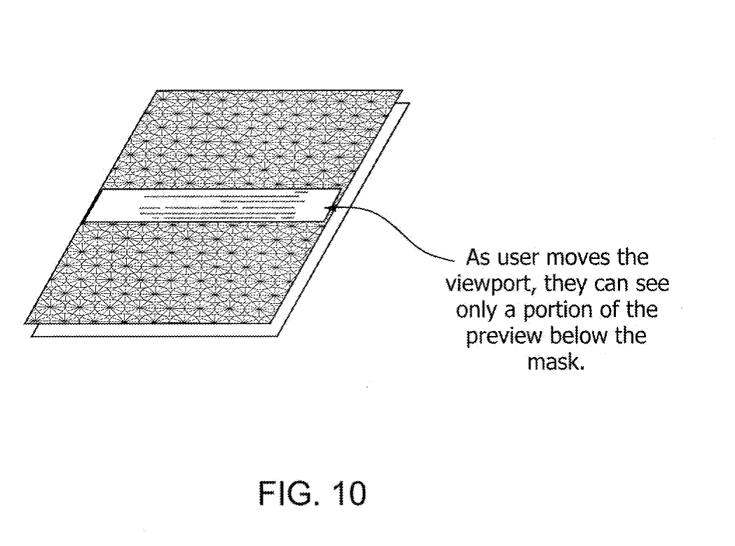

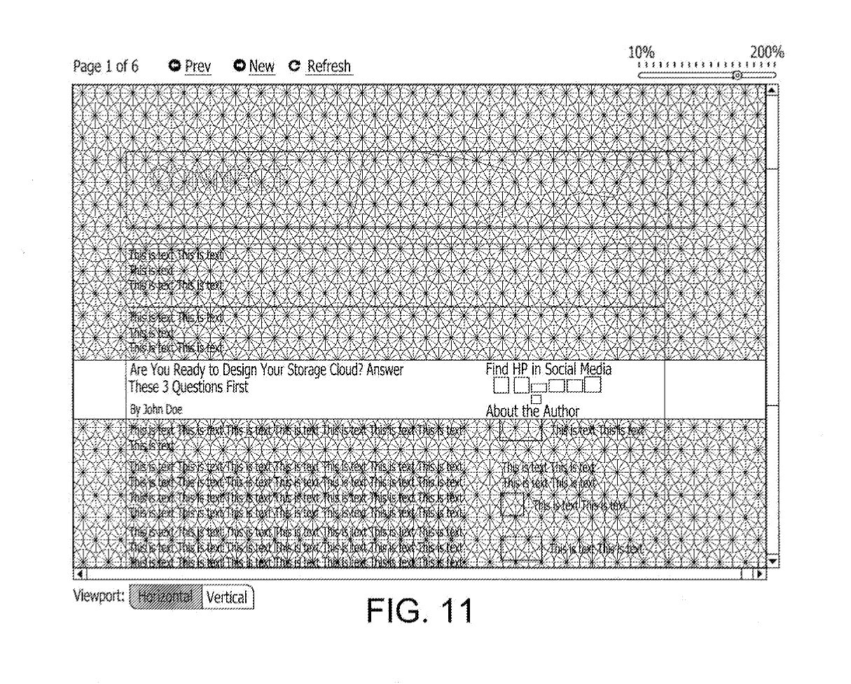

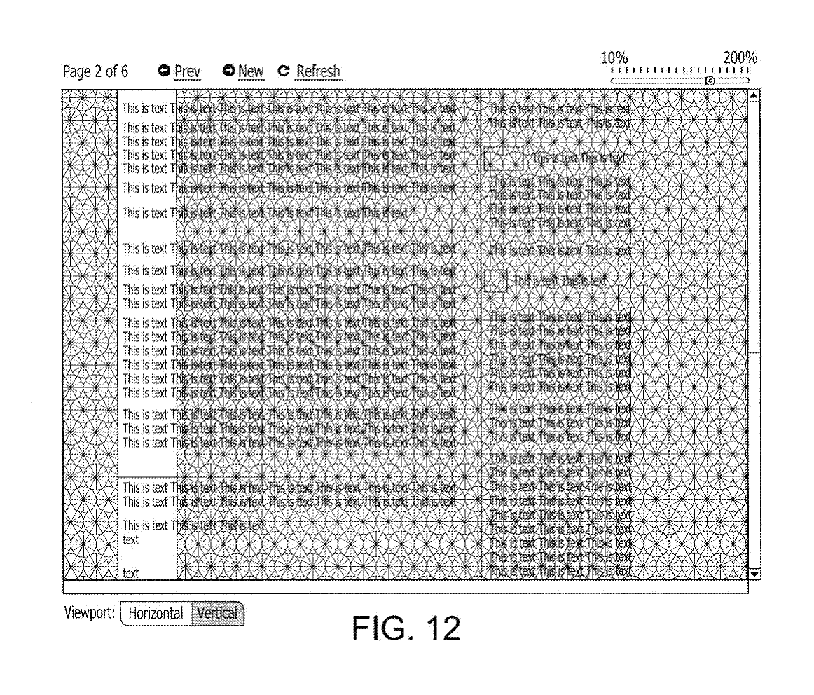

A top layer 1406 is provided which is the viewport. The viewport is designed as a “window” through the mask 1404 to see the underlying preview 1402. As shown in FIGS. 10-12, users can, for example, move the viewport with their mouse or touchpad on a desktop or laptop computer, or by sliding a tab control on a mobile device. The viewport then moves across the mask, displaying either a column (of set or variable width) or row (of set or variable height/rows) oriented “window” over the preview.

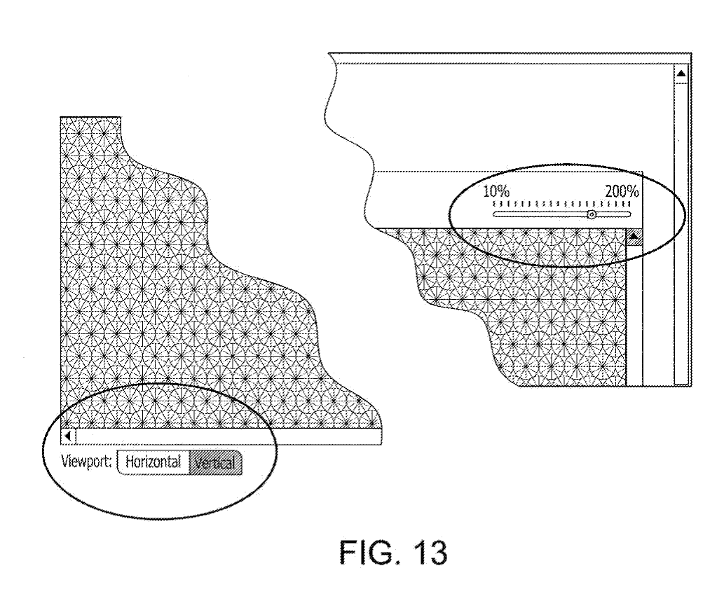

Referring to FIG. 13, the system can include a selection device, such as a electronic button, which allows a user to select between the horizontal and vertical viewports. The system may also include a slidebar for a zoom feature to permit the underlying text to be increased in size or the viewport size may be varied. Although the above description illustrates the viewport as a separate layer, it is contemplated that the viewport may be formed by forming an opening in the mask layer and changing the location of the formed window based on the underlying text that needs to be viewed.

Another optional feature of the present system is a positive recipient identification feature. Many of the currently available file and document sharing platforms do not have features to limit the ability of digital assets reaching unintended recipients or to track recipients that have accessed assets. Systems that permit public access (e.g. no security) to a digital asset (document, file, etc.) are offered with most services. In such public accessible systems, there is typically very little information that can be collected about recipients. If a user opens a link to a document, even though it may have optional password protection enabled, there is no way to confirm that the recipient is in fact who they say they are, and not a third party to which the password was provided. There are complex in-house systems available in the marketplace to issue client certificates to help with this problem, but implementation of such systems on an enterprise's customer base or for use with external third parties is usually not practical due to manpower requirements, complexity and cost of the infrastructure.

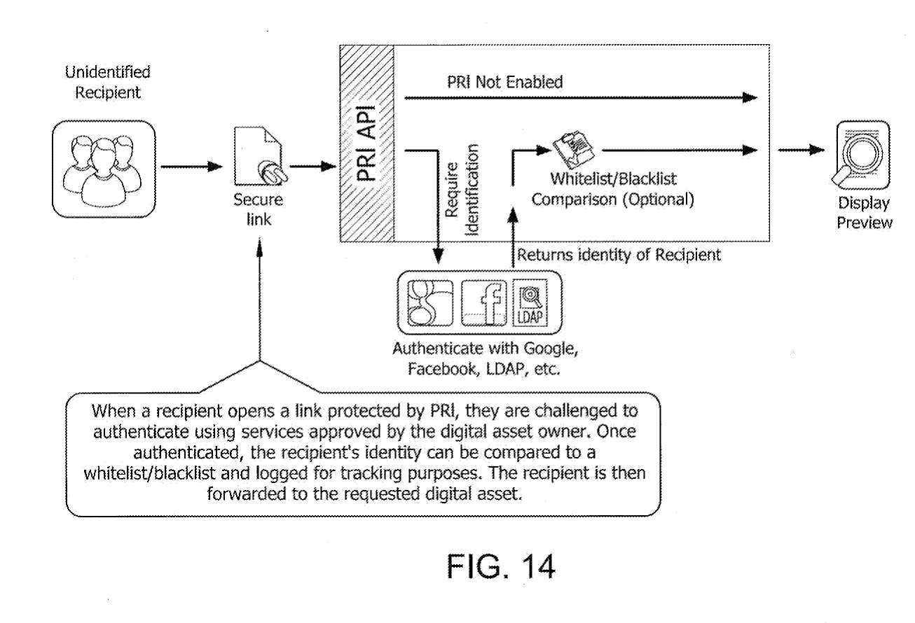

The present system may include a software module that prevents or at least limits unintended third party recipients and can track recipients through an easy-to-use addition to the sharing documents platform using multiple authentication options. Referring to FIG. 14, the Positive Recipient Identification (PRI) system operates as follows.

The Digital Asset Owner creates a whitelist, blacklist and authenticator policy. More specifically, the system administrators that oversee the implementation of the present system at a company have the ability to optionally specify an authentication policy for how PRI system will function for each Digital Asset Owner. The administrator or the Digital Asset Owner establishes a policy manager that includes a whitelist of authorized Digital Asset Consumers and blacklist of unauthorized third parties. This involves adding and removing email addresses and domain names from the lists. The PRI system also allows them to manage “active” authentication services, enable/disable public services (such as Facebook, Google, etc.), and register custom Lightweight Directory Access Protocol servers and group membership configurations. The settings are defined in the policy manager and take effect any time PRI system is enabled for a file or document link.

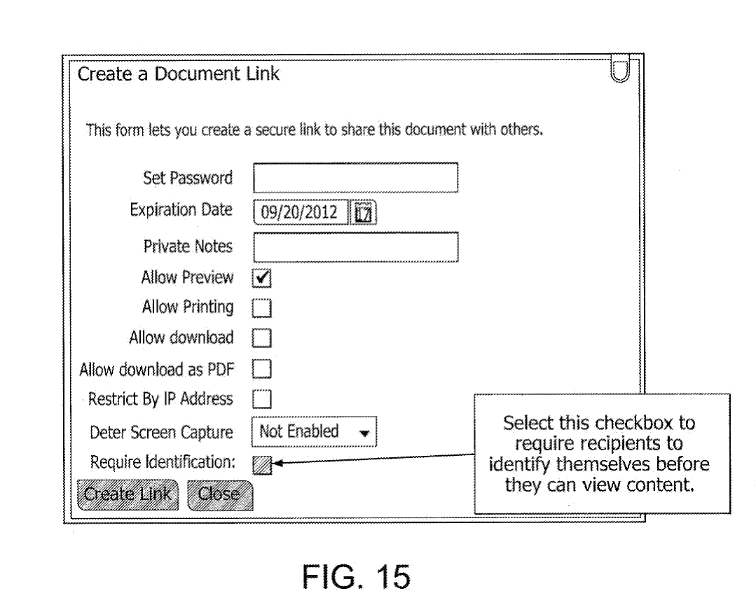

The system then allows the Digital Asset Owner to enable the PRI functionality for individual file and document links that are generated when it is desired. Referring to FIG. 15, a dialog box is shown that is generated by the system at the time that a Digital Asset Owner is creating a new file link. In the illustrated embodiment, the Digital Asset Owner clicks, checks or selects, the box for “require identification” and any other security options they would like to enable and then creates the link. The link can then be sent to any recipient via email or any other communication method. If a link is being generated programmatically using a developer API, then the necessary programming arguments are provided to enable this functionality in the method calls.

When the Digital Asset Consumer opens the link, the “require identification” feature will prompt the user to identify themselves by any of the system-enabled methods. These methods include any OAuth 2.0 or LDAP services registered in the system, including (but not limited to) Active Directory, Yahoo, Google, Microsoft Network (MSN), Facebook, etc.

The user chooses the method they prefer for authentication and proceeds to authenticate using their selected service. Upon successful authentication, the system captures the email address and full name of the authenticated user for inclusion in statistic logging and link tracking. If the Digital Asset Owner has created an optional whitelist or blacklist, the authenticated user's email address is compared and matched against the emails in those databases.

Although described in connection with preferred embodiments thereof, it will be appreciated by those skilled in the art that additions, deletions, modifications, and substitutions not specifically described may be made without departure from the spirit and scope of the invention.

1. A method of sharing digital assets comprising the steps of:
providing a first storage medium containing a virtual workspace containing links to multiple digital assets, at least a plurality of the digital assets being stored on one or more secondary storage mediums;
displaying at least some of the links to the digital assets in the workspace for an individual to access, the digital assets and the virtual workspace being stored in locations remote from the individual;
receiving a request from the individual to access one of the digital assets in the workspace;
confirming whether the individual has rights to access the digital asset;
retrieving a storage connector stored on the first storage medium, the storage connector being specifically associated with the digital asset;
using the storage connector to translate the request to access from the individual to a request to access associated with the digital asset; and
accessing the actual digital asset in response to the individual's request.

2. The method of claim 1, wherein the storage connector includes restrictions on actions that can be performed using the digital asset, and wherein the step of using the storage connector includes limiting the individual's use of the digital asset in accordance with the restrictions.

3. The method of claim 1 wherein there are multiple digital assets stored on multiple secondary storage mediums, the method further comprising the step of creating a storage connector to each digital asset on its storage medium, and storing the storage connector on the first computer useable medium.

4. The method of claim 3 wherein the storage connector includes encrypted functionality and security credentials for accessing the digital assets.

5. The method of claim 4 wherein the security credentials include login credentials for accessing the digital asset using a computer program stored on one of the secondary storage mediums; and wherein the step of accessing the actual digital asset involves providing the login credentials to the computer program for accessing the digital asset.

6. The method of claim 5 further comprising the step of associating a plurality of storage connectors with a workspace.

7. The method of claim 5 comprising the step of sending an electronic invitation to an individual to access the workspace, the electronic invitation including an internet link to a system controlling access to the workspace.

8. The method of claim 5 further comprising prompting an individual to enter credentials for accessing the workspace.

9. The method of claim 5 wherein at least one of the digital assets is accessible by a first computer program stored on one of the secondary storage mediums, and at least another of the digital assets is accessible by a second computer program stored on one of the secondary storage mediums, the second computer program being different from the first computer program, and wherein the individual's access to the digital assets involves using the first and/or second computer program, and wherein the storage connector includes credentials useable by the first or second computer program for accessing the digital asset.

10. The method of claim 9 wherein the storage connector includes programming which configures a command request from the individual into a request useable by the first or second program for executing the requested command.

11. The method of claim 5 wherein the first storage medium includes a bus for routing a request from one or more individuals for accessing a digital asset, the bus having storage connectors associated with it, the method comprising using the bus to determine which storage connector to use in response to receipt of a request from the individual.

12. The method of claim 10 further comprising locking a digital access from use by a second individual when the digital access is being accessed by the first individual.

13. The method of claim 1 including a document masking feature for use as a deterrent against unauthorized viewing by a third party and screen capture/scraping by unauthorized individuals, wherein the method involves obscuring a portion of the digital file by applying a layer on top of a portion of the view of the digital asset, the layer portion not obscuring the entire view of the digital asset, wherein the layer can be moved relative to the view of the digital asset so that that different portions of the view of the digital asset can be seen.

14. A method according to claim 5 further comprising the steps of creating a list of individuals permitting to access a workspace, the list including an electronic address and/or domain name associated with individuals permitted to access a workspace; requesting authentication of an individual attempting to access a workspace; receiving an electronic address and/or domain name associated with the individual; and comparing the electronic address and/or domain name to the list of permitted electronic addresses and/or domain names.

15. A method according to claim 14 further comprising the steps of capturing the electronic address and/or domain name for the individual and logging it into a file; and tracking the activities of the individual and storing the activities in the file.

16. A non-transitory computer program product stored on a first computer usable medium having a computer readable program code embodied therein, the computer readable program code adapted to be executed on a processor to implement a method for sharing files comprising:
creating at least one virtual workspace containing links to multiple digital assets, at least a plurality of the digital assets being stored on one or more secondary storage mediums distinct from the first computer usable medium and locate remote from the first computer usable medium;
displaying at least some of the links to the digital assets in the workspace for an individual to access, the digital assets and the virtual workspace being stored in locations remote from the individual;
receiving a request from the individual to access one of the digital assets in the workspace;
confirming whether the individual has rights to access the digital asset;
retrieving a storage connector stored on the first computer useable medium, the storage connector being specifically associated with the digital asset;
using the storage connector to translate the request to access from the individual to a request to access associated with the digital asset; and
accessing the actual digital asset in response to the individual's request.

17. The product of claim 16, wherein the storage connector includes restrictions on actions that can be performed using the digital asset, and wherein the step of using the storage connector includes limiting the individual's use of the digital asset in accordance with the restrictions.

18. The product of claim 16 wherein there are multiple digital assets stored on multiple secondary storage mediums, the method further comprising the step of creating a storage connector to each digital asset on its storage medium, and storing the storage connector on the first computer useable medium.

19. The product of claim 18 wherein the storage connector includes encrypted functionality and security credentials for accessing the digital assets.

20. The product of claim 19 wherein the security credentials include login credentials for accessing the digital asset using a computer program stored on one of the secondary storage mediums; and wherein the step of accessing the actual digital asset involves providing the login credentials to the computer program for accessing the digital asset.

21. An system including a processor configured to perform the following method:
creating at least one virtual workspace containing links to multiple digital assets, at least a plurality of the digital assets being stored on one or more secondary storage mediums distinct from the first computer usable medium and locate remote from the first computer usable medium;
displaying at least some of the links to the digital assets in the workspace for an individual to access, the digital assets and the virtual workspace being stored in locations remote from the individual;
receiving a request from the individual to access one of the digital assets in the workspace;
confirming whether the individual has rights to access the digital asset;
retrieving a storage connector stored on the first computer useable medium, the storage connector being specifically associated with the digital asset;
using the storage connector to translate the request to access from the individual to a request to access associated with the digital asset; and
accessing the actual digital asset in response to the individual's request.

22. The system of claim 21 wherein there are multiple workspaces, the apparatus further comprising a virtualization bus, the virtualization bus including the multiple workspaces, the virtualization bus configured to take requests from users for access to digital assets and select storage connector to satisfy the request from the user.

23. The system of claim 21 further comprising a document masking module for use as a deterrent against unauthorized viewing by a third party and screen capture/scraping by unauthorized individuals, wherein the masking feature includes programming that creates a layer that obscures a portion of a view of the digital asset, the layer portion not obscuring the entire view of the digital asset, wherein the programming permits the layer can be moved relative to the view of the digital asset so that that different portions of the view of the digital asset can be seen.
